(19) United States
(12) Patent Application Publication
(10) Pub. No.: US 2024/0388968 A1
(43) Pub. Date: Nov. 21, 2024

(54) COMMUNICATION DEVICE AND METHOD

(71) Applicant: NEC Corporation, Minato-ku, Tokyo (JP)

(72) Inventor: Shoki Inoue, Tokyo (JP)

(73) Assignee: NEC Corporation, Minato-ku, Tokyo (JP)

(21) Appl. No.: 18/693,191

(22) PCT Filed: Aug. 22, 2022
(86) PCT No.: PCT/JP2022/031575

§ 371 Date: Mar. 19, 2024

(30) Foreign Application Priority Data
Sep. 30, 2021 (JP) 2021-160256

(51) Int. Cl. H04W 28/20; H04W 28/14; H04W 72/0457

(52) U.S. Cl. CPC H04W 28/20; H04W 28/14; H04W 72/0457

(57) ABSTRACT

In order to provide a communication device that enables a transmitted data unit to be inferred regardless of a value of an identification number included in a response message, a first communication device for communicating with a terminal device together with a second communication device transmits control information indicating that the value of an identification number stored in memory of the second communication device is to be deleted, after receiving a response message including a first value of the identification number from the second communication device, and before transmitting a data unit including the same value as the first value of the identification number to the second communication device.

### TECHNICAL FIELD

The present invention generally relates to a mobile communication network.

### BACKGROUND ART

In Third Generation Partnership Project (3GPP (registered trademark)), dual connectivity in which user equipment (UE) as typified by a smart phone connects to both of two base stations (BSs) is defined, and is described in, for example, NPL 1.

In addition, in dual connectivity, the 3GPP defines a means for recognizing a status of data transmission by each base station. For example, NPL 2 describes that a downlink user data (DUD) message is transmitted from a packet data convergence protocol (PDCP) function unit of a base station that receives user data from a higher-level device to a radio link control (RLC) function unit of another base station, and a downlink data delivery status (DDDS) message is transmitted as a response thereto.

In addition, COUNT is defined as a sequence number in order to identify packets transmitted from one base station to a UE and another base station. For example, NPL 3 describes that COUNT is composed of two values being a hyper frame number (HFN) and a PDCP sequence number (SN), and only PDCP SN is included in the DUD message and the DDDS message.

### CITATION LIST

### Non Patent Literature

NPL 1: 3GPP TS 37.340 V16.6.0 (2021-06) 3rd Generation Partnership Project; Technical Specification Group Radio Access Network; Evolved Universal Terrestrial Radio Access (E-UTRA) and NR; Multi-connectivity; Stage 2 (Release 16)
NPL 2: 3GPP TS 38.425 V16.3.0 (2021-04) 3rd Generation Partnership Project; Technical Specification Group Radio Access Network; NG-RAN; NR user plane protocol (Release 16)
NPL 3: 3GPP TS 38.323 V16.4.0 (2021-06) 3rd Generation Partnership Project; Technical Specification Group Radio Access Network; NR; Packet Data Convergence Protocol (PDCP) specification (Release 16)

### SUMMARY OF INVENTION

### Technical Problem

As described above, the DUD message and the DDDS message include only the PDCP SN among the PDCP SN and the HFN constituting the COUNT. Therefore, the PDCP function unit of the base station that transmits the DUD message identifies the COUNT by estimating the HFN from the PDCP SN included in the DDDS message being received from the base station that receives the DUD message. Herein, the PDCP SN included in the DUD message increases by 1 from a minimum value toward a maximum value each time the DUD message is transmitted. When the PDCP SN reaches the maximum value, the PDCP SN returns to the minimum value and increases by 1 again.

Herein, a procedure of transmitting data to a terminal device by using dual connectivity performed by a first base station and a second base station is described. The first base station that receives data to be transmitted from a higher-level device to the terminal device transmits a DUD message including the data (hereinafter, sometimes referred to as “data unit”) and the PDCP SN to the second base station. The second base station that receives the DUD message transmits the DUD message to the terminal device. Upon completion of transmitting the DUD message to the terminal device, the second base station includes the PDCP SN of the last DUD message transmitted to the terminal device in a DDDS message as the highest transmitted NR PDCP sequence number (HTSN), and transmits the DDDS message to the first base station. In addition, the second base station may include, in the DDDS message, the PDCP SN included in the DUD message delivered by the second base station to the terminal device, that is, the PDCP SN included in the DUD message which has been received by the terminal device, as the highest successfully delivered NR PDCP sequence number (HDSN).

The first base station may infer the HFN from the PDCP SN included in the DDDS message as described below. For example, when a PDCP SN included in a DDDS message (hereinafter, sometimes referred to as a “current DDDS message”) received this time is smaller than a PDCP SN included in a DDDS message (hereinafter, sometimes referred to as an “old DDDS message”) received before the current DDDS message, it may be inferred that a value of the HFN increases by 1. In addition, when the PDCP SN included in the current DDDS message is larger than the PDCP SN included in the old DDDS message received before the current DDDS message, it may be inferred that the value of the HFN does not change.

However, when the value of the PDCP SN included in the current DDDS message is the same as the PDCP SN included in the old DDDS message received before the current DDDS message, there is a possibility that a problem arises in inference of the HFN. This is because the first base station is unable to distinguish from the PDCP SN whether the current DDDS message is a response to a DUD message transmitted at a timing closest to reception of the current DDDS message or a response to a DUD message transmitted before reception of the old DDDS message.

Therefore, the first base station performs processing in such a way that the PDCP SN included in a DUD message that is highly likely to correspond to the PDCP SN included in the current DDDS message is not the same as the PDCP SN included in the old DDDS message. This causes increasing a processing load of the first base station.

An object of the present disclosure is to solve the above-described problem, and to provide a communication device and a method that enable a transmitted data unit to be inferred regardless of a value of an identification number included in a response message.

It should be noted that this object is only one of objects to be achieved by example embodiments disclosed herein. Other objects or problems and novel features will be apparent from description of the present description or the accompanying drawings.

### Solution to Problem

A communication device according to a first aspect of the present disclosure is a first communication device that communicates with a terminal device together with a second communication device, and includes: a transmission means for sequentially transmitting, via the second communication device or directly to the terminal device, a plurality of messages including a plurality of data units in which an identification number is assigned to each data unit, wherein a value of the identification number circulates in such a way as to increase from a minimum value, reach a maximum value, and then return to the minimum value; and a reception means for receiving, from the second communication device, a response message including a value of the identification number being held in a memory provided in the second communication device, the value of the identification number being included in the last data unit transmitted from the second communication device to the terminal device before a response reference timing of the second communication device, wherein the transmission means transmits, to the second communication device, control information indicating that the value of the identification number being stored in the memory provided in the second communication device is to be deleted, after the reception means receives a response message including a first value of the identification number, and before the transmission means transmits a data unit including the same value as the first value of the identification number.

A communication device according to a first aspect of the present disclosure is a second communication device that communicates with a terminal device together with a first communication device, and includes: a reception means for sequentially receiving, from the first communication device, a plurality of messages including a plurality of data units in which an identification number is assigned to each data unit, wherein a value of the identification number circulates in such a way as to increase from a minimum value, reach a maximum value, and then return to the minimum value; and a transmission means for transmitting, to the first communication device, a response message including a value of the identification number held in a memory of the second communication device, the value of the identification number being included in the last data unit received before a response reference timing of the second communication device, wherein the reception means receives, from the first communication device, control information indicating that the value of the identification number being stored in the memory provided in the second communication device is to be deleted, after the transmission means transmits a response message including a first value of the identification number, and before the reception means receives a data unit including the same value as the first value of the identification number.

A method according to a first aspect of the present disclosure is a method of a first communication device communicating with a terminal device together with a second communication device, and includes: sequentially transmitting, via the second communication device or directly to the terminal device, a plurality of messages including a plurality of data units in which an identification number is assigned to each data unit, wherein a value of the identification number circulates in such a way as to increase from a minimum value, reach a maximum value, and then return to the minimum value; receiving, from the second communication device, a response message including a value of the identification number being held in a memory provided in the second communication device, the value of the identification number being included in the last data unit transmitted from the second communication device to the terminal device before a response reference timing of the second communication device; and transmitting, to the second communication device, control information indicating that the value of the identification number being stored in the memory provided in the second communication device is to be deleted, after receiving a response message including a first value of the identification number, and before transmission means transmits a data unit including the same value as the first value of the identification number.

### Advantageous Effects of Invention

According to the present disclosure, it is possible to provide a communication device and a method that enable a transmitted data unit to be inferred regardless of a value of an identification number included in a response message.

### BRIEF DESCRIPTION OF DRAWINGS

FIG. 1 is an explanatory diagram for describing an example of a communication device 1 according to a first example embodiment.

FIG. 2 is an explanatory diagram for describing an example of a communication device 2 according to the first example embodiment.

FIG. 3 is a flowchart for describing an operation example of the communication device 1 according to the first example embodiment.

FIG. 4 is an explanatory diagram for describing an example of a communication device 3 according to a second example embodiment.

FIG. 5 is an explanatory diagram for describing an example of a communication device 4 according to the second example embodiment.

FIG. 6 is an explanatory diagram for describing an example of a message according to the second example embodiment.

FIG. 7 is a flowchart for describing an operation example of the communication device 3 according to the second example embodiment.

FIG. 8 is a flowchart for describing an operation example of the communication device 3 according to the second example embodiment.

FIG. 9 is a flowchart for describing an operation example of the communication device 4 according to the second example embodiment.

FIG. 10 is a flowchart for describing an operation example of the communication device 4 according to the second example embodiment.

FIG. 11 is an explanatory diagram for describing an example of a communication device 5 according to a third example embodiment.

FIG. 12 is an explanatory diagram for describing an example of a communication device 6 according to the third example embodiment.

FIG. 13 is a flowchart for describing an operation example of the communication device 5 according to the third example embodiment.

FIG. 14 is a flowchart for describing an operation example of the communication device 5 according to the third example embodiment.

FIG. 15 is a flowchart for describing an operation example of the communication device 6 according to the third example embodiment.

FIG. 16 is a flowchart for describing an operation example of the communication device 6 according to the third example embodiment.

FIG. 17 is an explanatory diagram for describing an example of a communication device 7 according to a fourth example embodiment.

FIG. 18 is an explanatory diagram for describing an example of a communication device 8 according to the fourth example embodiment.

FIG. 19 is a flowchart for describing an operation example of the communication device 7 according to the fourth example embodiment.

FIG. 20 is a flowchart for describing an operation example of the communication device 8 according to the fourth example embodiment.

FIG. 21 is an explanatory diagram for describing a configuration example of the communication device according to each of the example embodiments.

### EXAMPLE EMBODIMENT

Hereinafter, specific example embodiments are described in detail with reference to the drawings. In the drawings, the same or corresponding element is denoted by the same reference sign, and redundant description is omitted as necessary in order to simplify the description.

The following example embodiments may be implemented independently or in combination as appropriate. The plurality of example embodiments have novel features that are different from one another. Therefore, the plurality of example embodiments contribute to solving different objects or problems, and contribute to achieving effects different from one another.

As used in the present description, depending on the context, “if” may be interpreted to mean “when”, “at or around the time”, “after”, “upon”, “in response to determining”, “in accordance with a determination”, or “in response to detecting”. These expressions may be interpreted as having the same meaning depending on the context.

### First Example Embodiment

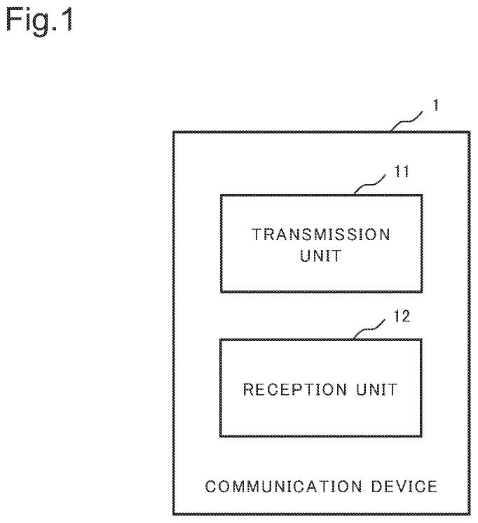

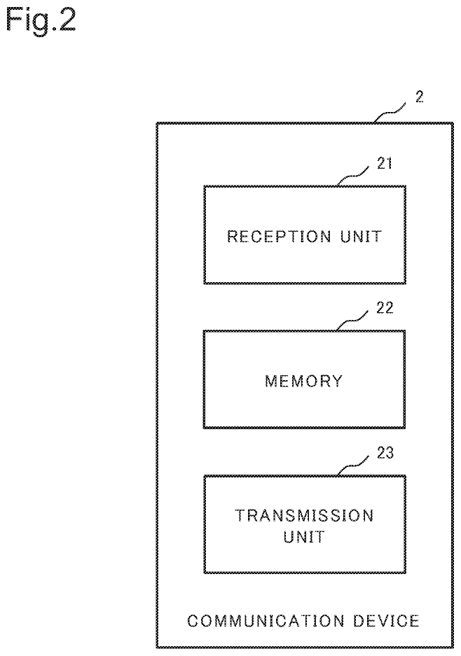

FIG. 1 illustrates a configuration example of a communication device 1 according to the present example embodiment, and FIG. 2 illustrates a configuration example of a communication device 2 according to the present example embodiment. Each element illustrated in FIGS. 1 and 2 may be implemented, for example, as dedicated hardware, as software running on dedicated hardware, or as a virtualization function instantiated on an application platform running on general purpose hardware. For example, the communication device 1 and the communication device 2 may be a base station supporting a communication scheme defined in Third Generation Partnership Project (3GPP) such as Long Term Evolution (LTE) and New Radio (NR). Further, the communication device 1 and the communication device 2 may be a base station supporting dual connectivity that performs communication with a terminal device by using two base stations as defined in 3GPP, or multi-connectivity that performs communication with a terminal device by using three or more base stations. The base station is connected to, for example, a terminal device and a core network supporting LTE and NR. The base station and the core network are connected by an S1 interface or an NG interface, and the base stations are connected to one another by an X2 interface or an Xn interface, but the present invention is not limited thereto.

In FIG. 1, the communication device 1 includes a transmission unit 11 and a reception unit 12.

The transmission unit 11 is configured to sequentially transmit, via the communication device 2 or directly to the terminal device, a plurality of messages including a plurality of data units in which an identification number is assigned to each data unit. In addition, the value of the identification number circulates in such a way as to increase from the minimum value, reach the maximum value, and then return to the minimum value.

The reception unit 12 is configured to receive a response message from the communication device 2. The response message includes, for example, a value of an identification number being stored in a memory 22 of the communication device 2, the value of the identification number being included in a data unit of the last message transmitted by the communication device 2 to the terminal device before the response reference timing of the communication device 2.

In addition, the transmission unit 11 is configured to transmit, to the communication device 2, control information indicating that the value of the identification number stored in the memory provided in the communication device 2 is to be deleted, after the reception unit 12 has received the response message including a first value of the identification number and before the transmission unit 11 transmits a data unit including the same value as the first value of the identification number.

In FIG. 2, the communication device 2 includes a reception unit 21, the memory 22, and a transmission unit 23.

The reception unit 21 is configured to sequentially receive, from the communication device 1, a plurality of messages including a plurality of data units in which an identification number is assigned to each data unit. The value of the identification number circulates in such a way as to increase from the minimum value, reach the maximum value, and then return to the minimum value. The message may be, for example, a downlink user data (DUD) message.

The memory 22 is configured to overwrite and store the value of the identification number included in the message transmitted by the transmission unit 23 to the terminal device. That is, the memory 22 stores the value of the identification number included in the last message transmitted by the transmission unit 23 to the terminal device.

The transmission unit 11 transmits to the terminal device a message including the data unit received by the reception unit 12.

The transmission unit 23 is configured to transmit, to the communication device 1, a response message including the value of the identification number held in the memory 22, the value of the identification number being included in the data unit of the last message transmitted by the communication device 2 to the terminal device before the response reference timing of the communication device 2. The response message may be, for example, a downlink data delivery status (DDDS) message.

In addition, the reception unit 21 is configured to receive, from the communication device 1, control information indicating that the value of the identification number stored in the memory 22 is to be deleted. As described above, the control information is transmitted from the communication device 1 after the transmission unit 23 has transmitted the response message including the first value of the identification number, and before the reception unit 21 receives the data unit including the same value as the first value of the identification number.

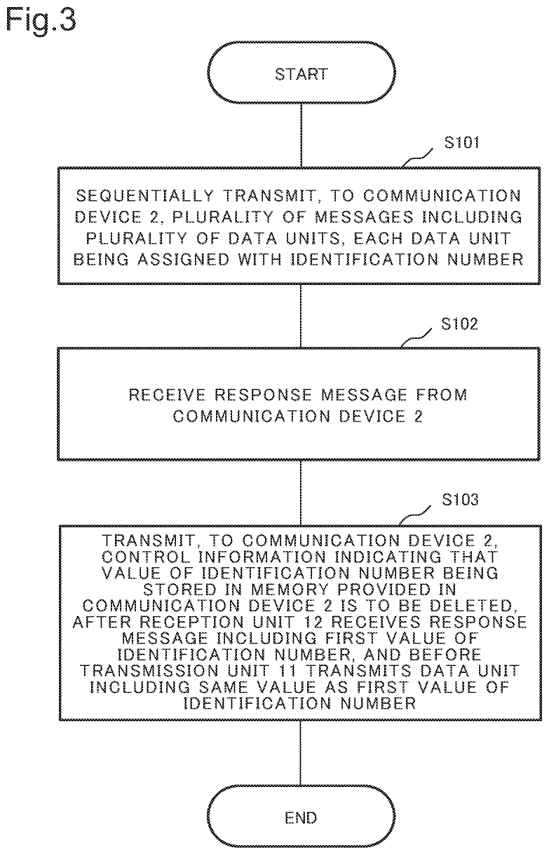

Next, an operation example of the communication device 1 according to the first example embodiment is described with reference to FIG. 3. FIG. 3 is a flowchart illustrating an operation example of the communication device 1 according to the first example embodiment.

First, the transmission unit 11 sequentially transmits, to the communication device 2, a plurality of messages including a plurality of data units in which an identification number is assigned to each data unit (S101). The value of the identification number circulates in such a way as to increase from the minimum value, reach the maximum value, and then return to the minimum value.

The reception unit 12 receives the response message from the communication device 2 (S102). The response message includes the value of the identification number held in the memory 22 of the communication device 2, the value of the identification number being included in the data unit of the last message transmitted by the communication device 2 to the terminal device before the response reference timing of the communication device 2. Herein, it is assumed that the value of the identification number included in the response message is the first value.

The transmission unit 11 transmits, to the communication device 2, control information indicating that the value of the identification number being stored in the memory provided in the communication device 2 is to be deleted, after the reception unit 12 has received the response message including the first value of the identification number and before the transmission unit 11 transmits the data unit including the same value as the first value of the identification number (S103).

As described above, the communication device 1 is able to transmit, to the communication device 2, the control information indicating that the value of the identification number being stored in the memory provided in the communication device 2 is to be deleted, after the reception unit 12 has received the response message including the first value of the identification number and before the transmission unit 11 transmits the data unit including the same value as the first value of the identification number. Therefore, the communication device 1 is able to infer the transmitted data unit, regardless of the value of the identification number included in the response message.

### Second Example Embodiment

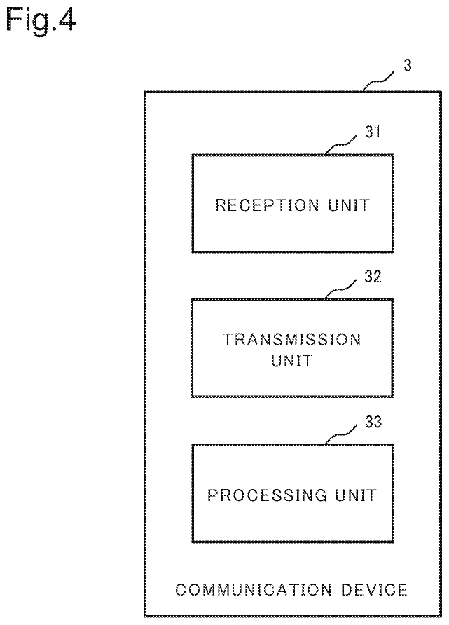

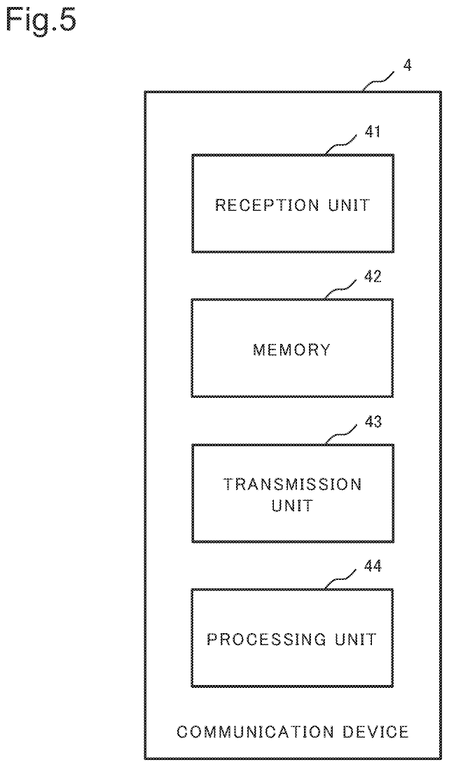

FIG. 4 illustrates a configuration example of a communication device 3 according to the present example embodiment, and FIG. 5 illustrates a configuration example of a communication device 4 according to the present example embodiment. The communication device 3 corresponds to the communication device 1 according to the first example embodiment, and the communication device 4 corresponds to the communication device 2 according to the first example embodiment.

For example, the communication device 3 and the communication device 4 may be base stations supporting a communication scheme defined in Third Generation Partnership Project (3GPP) such as Long Term Evolution (LTE) and New Radio (NR). In addition, the communication device 3 and the communication device 4 may be a base station supporting dual connectivity that performs communication with a terminal device by using two base stations as defined in 3GPP, or multi-connectivity that performs communication with a terminal device by using three or more base stations. For example, at least one of the communication device 3 and the communication device 4 may be a base station communicating with a terminal device by using a dual connectivity split bearer. One of the communication device 3 and the communication device 4 is any one of a central unit (CU) of a base station, a master base station in dual connectivity, and a secondary base station in dual connectivity, and the other is any one of a distributed unit (DU) of a base station, a master base station in dual connectivity, and a secondary base station in dual connectivity. Each of the communication device 3 and the communication device 4 is a master base station or a secondary base station, and may be referred to as a master eNB (MeNB), a secondary eNB (SeNB), a master gNB (MgNB), a secondary gNB (SgNB), or an en-gNB. The communication device 3 and the communication device 4 may be connected through an X2 interface or an Xn interface defined by 3GPP, but is not limited thereto.

In FIG. 4, the communication device 3 includes a reception unit 31, a transmission unit 32, and a processing unit 33. The reception unit 31 corresponds to the reception unit 12 according to the first example embodiment, and the transmission unit 32 corresponds to the transmission unit 11 according to the first example embodiment.

The reception unit 31 of the communication device 3 is configured to receive downlink data (user plane, U-Plane) and a control plane (C-Plane) from a higher-level device. The higher-level device may be a core network node or a core network. For example, the core network node may be an EPC connected to the communication devices 3 and 4 through an S1 interface defined by 3GPP, or a 5GC connected to the communication devices 3 and 4 through an NG interface.

In addition, the reception unit 31 of the communication device 3 is configured to receive a downlink data delivery status (DDDS) message transmitted by the communication device 4 described later.

The transmission unit 32 is configured to transmit a downlink user data (DUD) message to at least either of the communication device 4 described later, or the terminal device. That is, a downlink user data (DUD) message is transmitted from the communication device 3 via the communication device 4 or directly to the terminal device. A plurality of DUD messages may be transmitted. Each DUD message may include a different packet data convergence protocol sequence number (PDCP SN) as an identification number that identify the packets of downlink data. Typically, the PDCP SN is included in a data portion that stores downlink data in a DUD message. Each time a DUD message is sent, the PDCP SN increases by one, and when the maximum value is reached, the PDCP SN returns to the minimum value and again increases by one.

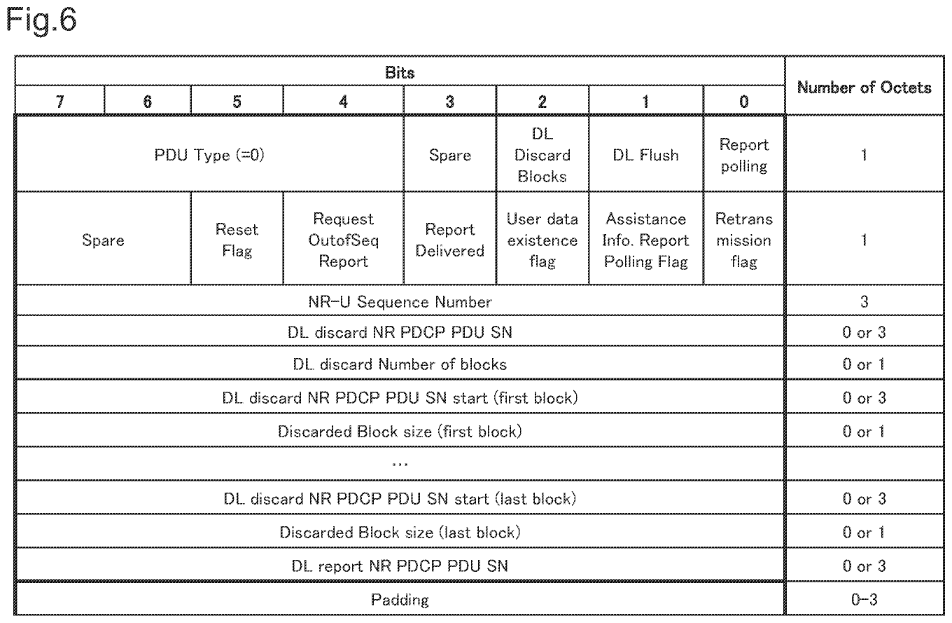

In addition, the transmission unit 32 is configured to transmit a message including a reset flag to the communication device 4. The message including a reset flag may be, for example, a DUD message. When a DUD message is used as the message including a reset flag, the message including a reset flag may be a DUD message including only a header portion and without a data portion. Such a DUD message having only a header portion may be used as a control message for another communication device. FIG. 6 illustrates a configuration example of a message including a reset flag by using a DUD message. A reset flag is information indicating an instruction to cause the communication device 4 to reset a memory, which is included in the communication device 4 described later and in which the PDCP SN is stored, and to delete the PDCP SN being stored in the memory.

There are several possible timings at which the transmission unit 32 transmits the message including a reset flag. For example, the control information may be transmitted after the PDCP SN has changed. The control information may be transmitted at a time when the value of the PDCP SN becomes 0. The control information may be transmitted before the most significant bit of the PDCP SN changes. The control information may be transmitted after the most significant bit of the PDCP SN changes. Note that, the control data is, for example, a message including a reset flag. Further, immediately after the reception unit 31 has received the DDDS message from the communication device 4, the transmission unit 32 may transmit the message including a reset flag to the communication device 4. The transmission unit 32 may transmit the message including a reset flag, immediately after the PDCP SN included in the DUD message has returned to the minimum value. The transmission unit 32 may transmit the message including a reset flag, immediately before transmitting the DUD message including the same PDCP SN as a PDCP SN included in a DUD message transmitted in the past. In short, it is only necessary to transmit the message including a reset flag prior to transmitting the DUD message including the same PDCP SN as the PDCP SN included in the DUD message transmitted in the past.

The processing unit 33 is configured to determine that a DDDS message being received after the transmission unit 32 has transmitted the message including a reset flag is not a response to a DUD message transmitted prior to transmitting the message including a reset flag, but a response to a DUD message transmitted after transmitting the message including a reset flag.

In FIG. 5, the communication device 4 includes a reception unit 41, a memory 42, a transmission unit 43, and a processing unit 44. The reception unit 41 corresponds to the reception unit 21 according to the first example embodiment. The memory 42 corresponds to the memory 22 according to the first example embodiment. The transmission unit 43 corresponds to the transmission unit 23 according to the first example embodiment.

The reception unit 41 is configured to receive a DUD message from the communication device 3. As described above, the DUD message being transmitted from the communication device 3 includes a DUD message including a data unit and a DUD message including a reset flag and not including a data unit.

The memory 42 is configured to store a PDCP SN included in a transmitted DUD message, each time the transmission unit 43 described later transmits the DUD message to the terminal device, by the processing unit 44 described later. In addition, regarding the PDCP SN stored in the memory 42, the PDCP SN being stored in the memory 42 by the processing unit 44 is overwritten by a PDCP SN included in a DUD message newly transmitted by the transmission unit 43, each time the transmission unit 43 transmits a DUD message.

The transmission unit 43 is configured to transmit the DUD message received from the communication device 3 to the terminal device. In addition, the transmission unit 43 is configured to read out the PDCP SN stored in the memory 42, and transmit the PDCP SN by including the read out PDCP SN in a DDDS message. The transmission unit 43 may transmit the DDDS message, triggered by the current time reaching the response reference time. The response reference time is a time used as a reference for the timing of generation and transmission of the DDDS message. The response reference time may be, for example, a time that repeatedly occurs at predetermined time intervals (that is, periodically) or at predetermined number of times of transmission of the DUD message. Furthermore, the PDCP SN included in the DDDS message may be the highest transmitted NR PDCP sequence number (HTSN) defined by 3GPP, or may be the highest successfully delivered NR PDCP sequence number (HDSN), a successfully delivered retransmitted NR PDCP sequence number (SDSN), or a retransmitted NR PDCP sequence number (RSN). In some cases, a DDDS message that is not a response to the DUD message may be transmitted. The DDDS message in such a case does not include values such as HTSN and HDSN. In addition, after the reception unit 41 has received the message including a reset flag, the transmission unit 43 may transmit the DDDS message not including the values such as HTSN and HDSN to the communication device 3. Further, the transmission unit 43 may not transmit the DDDS message after the reception unit 41 has received the message including a reset flag.

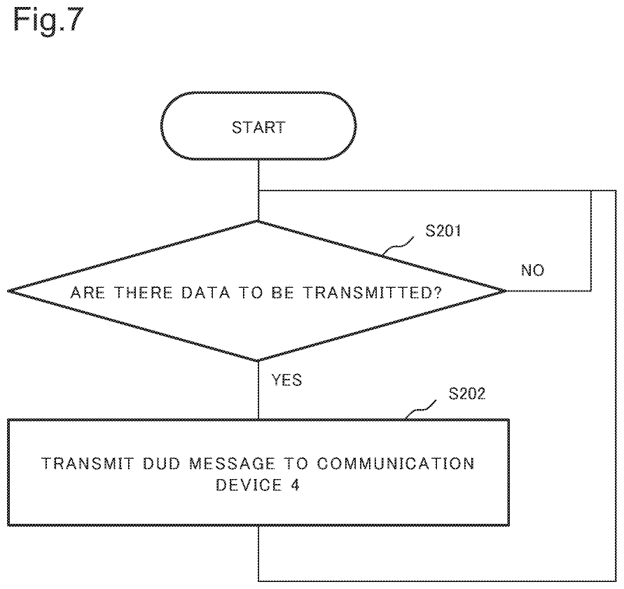

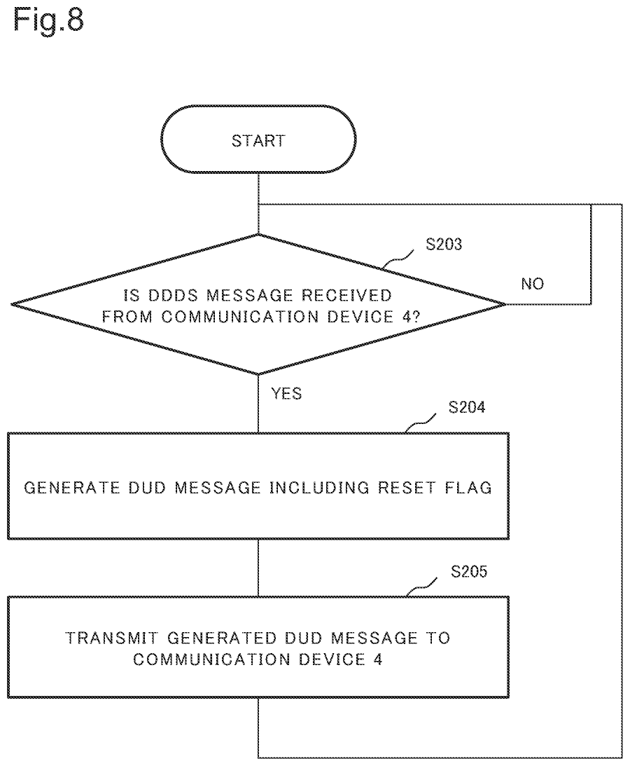

The processing unit 44 is configured to delete the value of the PDCP SN being stored in the memory 42 (that is, null the value of the PDCP SN being stored in the memory 42) when the reception unit 41 received a message including a reset flag from the communication device 3. Such deletion processing may be resetting of the memory 42. Next, an operation example of the communication device 3 according to the second example embodiment is described with reference to FIGS. 7 and 8.

FIGS. 7 and 8 are flowcharts illustrating one example of a processing operation performed by the communication device 3. FIG. 7 relates in particular to the transmission of a DUD message. FIG. 8 relates in particular to the reception of a DDDS message and the transmission of a message including a reset flag.

In FIG. 7, the transmission unit 32 determines whether there is data to be transmitted (S201). When it is determined that there is data to be transmitted (S201, YES), the transmission unit 32 transmits a DUD message (S202). Then, the processing step returns to S201. As described above, the DUD message includes a plurality of data units assigned with identification numbers. The value of the identification number circulates in such a way as to increase from the minimum value, reach the maximum value, and then return to the minimum value. When it is determined that there is no data to be transmitted (S201, NO), the transmission unit 32 executes the processing of S201 again.

In FIG. 8, the transmission unit 32 determines whether the reception unit 31 has received the DDDS message from the communication device 4 (S203). When it is determined that the reception unit 31 has received the DDDS message from the communication device 4 (S203, YES), the transmission unit 32 generates a DUD message including a reset flag (S204), and transmits the generated DUD message to the communication device 4 (S205). Then, the processing step returns to S203. When it is determined that there is no data to be transmitted (S203, NO), the transmission unit 32 executes the processing of S203 again.

Herein, although a case where the communication device 3 transmits the DUD message including a reset flag as soon as the communication device 3 receives the DDDS message has been exemplified, the present example embodiment is not limited to this. That is, as described above, the transmission unit 32 may transmit the message including a reset flag immediately after the PDCP SN included in the DUD message has returned to the minimum value. The transmission unit 32 may transmit the message including a reset flag, immediately before transmitting a DUD message including the same PDCP SN as the PDCP SN included in a DUD message transmitted in the past. In short, it is only necessary to transmit a message including a reset flag, prior to transmitting a DUD message including the same PDCP SN as the PDCP SN included in the DUD message transmitted in the past.

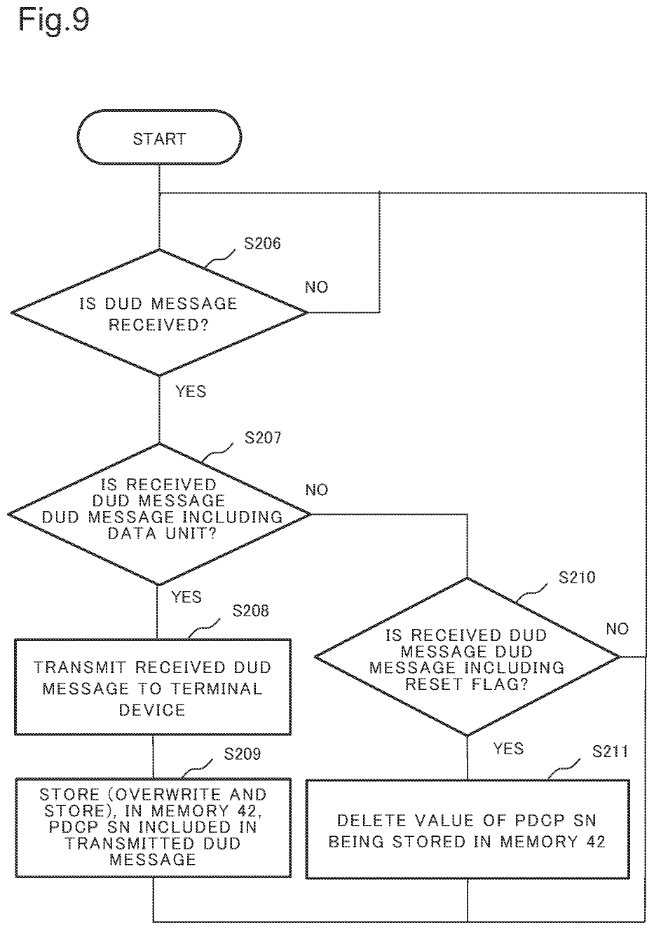

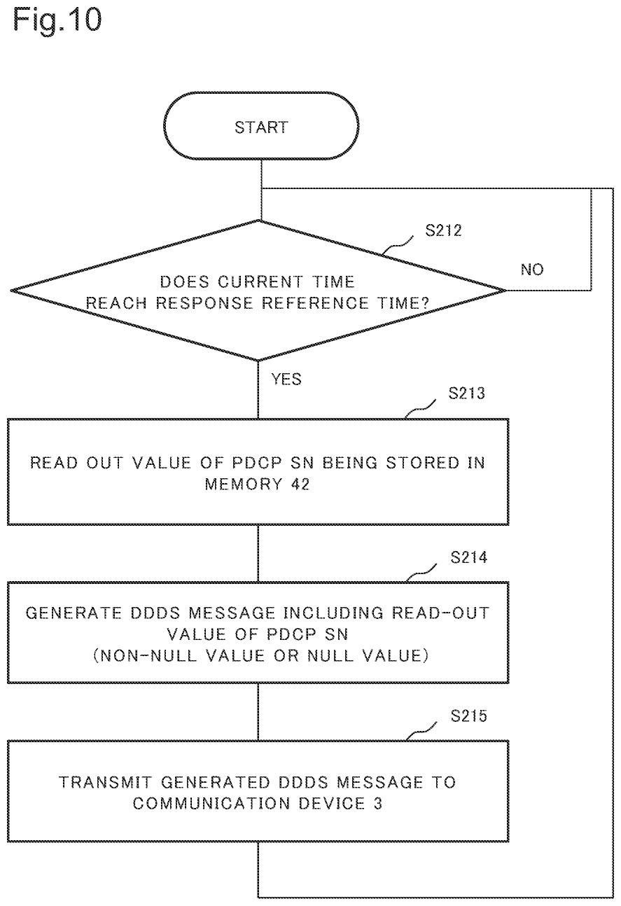

Next, an operation example of the communication device 4 according to the second example embodiment is described with reference to FIGS. 9 and 10.

FIGS. 9 and 10 are flowcharts illustrating one example of a processing operation performed by the communication device 4. FIG. 9 relates in particular to storing and deleting a PDCP SN. FIG. 10 relates in particular to the transmission of a DDDS message.

In FIG. 9, the processing unit 44 determines whether the reception unit 41 has received the DUD message (S206). When the processing unit 44 determines that the reception unit 41 has received the DUD message (S206, YES), the processing unit 44 determines whether the received DUD message is a DUD message including a data unit (S207). When it is determined that there is no data to be transmitted (S206, NO), the reception unit 41 executes the processing of S204 again.

When it is determined that the received DUD message is a DUD message including a data unit (S207, YES), the transmission unit 43 transmits the received DUD message to the terminal device (S208).

Then, the processing unit 44 stores (overwrites and stores) in the memory 42 the value of the PDCP SN included in the transmitted DUD message (S209).

Meanwhile, when it is determined that the received DUD message is a DUD message that does not include a data unit (S207, NO), the processing unit 44 determines whether the received DUD message is a DUD message that includes a reset flag (S210). When it is determined that the received DUD message is a DUD message including a reset flag (S210, YES), the processing unit 44 deletes the value of the PDCP SN being stored in the memory 42 (S211). When it is determined that the received DUD message is not a DUD message including a reset flag (S210, NO), the processing of S204 is executed again. Accordingly, it is possible to prevent the value of the PDCP SN included in the previous DDDS message from being transmitted again in the next DDDS message. Then, the processing step returns to S204.

In FIG. 10, the processing unit 44 determines whether the current time has reached the response reference time (S212). When it is determined that the current time has not reached the response reference time (S212, NO), the processing of S212 is executed again.

When it is determined that the current time has reached the response reference time (S212, YES), the transmission unit 43 reads out the value of the PDCP SN being stored in the memory 42 (S213).

The transmission unit 43 generates a DDDS message including the read out value (non-null value or null value) of the PDCP SN (S214), and transmits the generated DDDS message to the communication device 3 (S215). Then, the processing step returns to S210. Herein, description is made assuming that a DDDS message including a null value is transmitted, but the present example embodiment is not limited to this. For example, when the read value of the PDCP SN is a null value, the transmission unit 43 does not need to generate and transmit the DDDS message.

As described above, the communication device 3 is able to transmit a message including a reset flag to the communication device 4. Accordingly, it is possible to prevent the value of the PDCP SN included in the previous DDDS message from being transmitted again in the next DDDS message. Therefore, the communication device 3 is able to infer the values of HFN and COUNT regardless of the value of the PDCP SN being included in the DDDS message.

### Third Example Embodiment

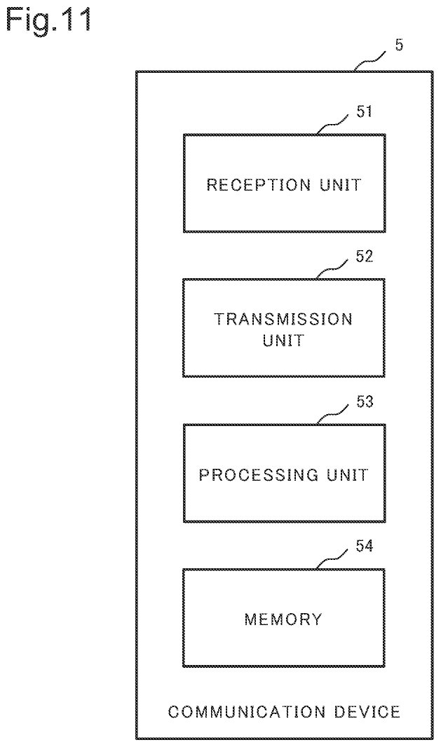

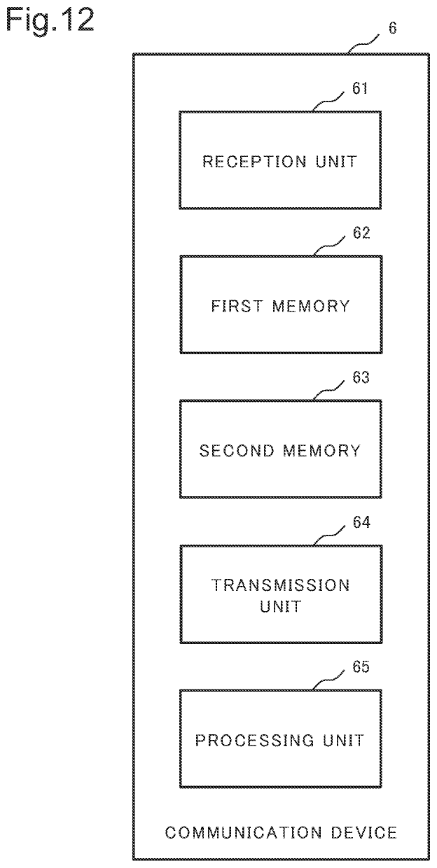

FIG. 11 illustrates a configuration example of a communication device 5 according to the present example embodiment, and FIG. 12 illustrates a configuration example of a communication device 6 according to the present example embodiment. The communication device 5 corresponds to the communication device 3 according to the second example embodiment, and the communication device 6 corresponds to the communication device 4 according to the second example embodiment.

In FIG. 11, the communication device 5 includes a reception unit 51, a transmission unit 52, a processing unit 53, and a memory 54. The reception unit 51 corresponds to the reception unit 31 according to the second example embodiment, and the transmission unit 52 corresponds to the transmission unit 32 according to the second example embodiment. Note that, among the operations of the communication device 5, the same operation as those of the communication device 3 according to the second example embodiment is omitted as appropriate.

The reception unit 51 is configured to wait for a certain period of time for reception of a DDDS message from the communication device 6, after the transmission unit 52 described later transmits the DUD message. The reception unit 51 may set a timer that waits for the reception of the DDDS message from the communication device 6, start the timer, and wait for the reception of the DDDS message until the timer expires. The time for the reception unit 51 to wait may be set in advance in the reception unit 51 or may be set from an external device such as the communication device 5. Further, the DDDS message waiting for reception may be a DDDS message that is a response to the DUD message transmitted by the transmission unit 52.

The processing unit 53 is configured to store, in the memory 54 described later, the PDCP SN included in the DUD message, after the transmission unit 52 has transmitted the DUD message. In addition, the processing unit 53 is configured to set or reset a timer that waits for the reception of the DDDS message in response to the transmission of the DUD message by the transmission unit 52, and start the timer. The processing unit 53 is configured to, when the DDDS message is not received even when the timer expires, determine that the transmission of the DUD message is successful. The processing unit 53 may be configured to, when the timer waiting for the reception of the DDDS message from the communication device 6 set by the reception unit 51 expires, determine that the PDCP SN included in the DUD message transmitted by the transmission unit 52 is the same as the PDCP SN included in a DUD message transmitted before such DUD message, and the transmission of such DUD message is successful.

The memory 54 is configured to store the PDCP SN included in the DUD message transmitted by the transmission unit 52. If the PDCP SN is already stored in the memory 54, the processing unit 53 may overwrite and store the new PDCP SN on the PDCP SN that has already been stored.

In FIG. 12, the communication device 6 includes a reception unit 61, a first memory 62, a transmission unit 64, and a processing unit 65. The reception unit 61 corresponds to the reception unit 41 according to the second example embodiment. The first memory 62 corresponds to the memory 42 according to the second example embodiment. The transmission unit 64 corresponds to the transmission unit 43 according to the second example embodiment. The processing unit 65 corresponds to the processing unit 44 according to the second example embodiment. Note that, among the operations of the communication device 6, the same operation as those of the communication device 4 according to the second example embodiment is omitted as appropriate.

The first memory 62 is configured to store a PDCP SN of a DUD message transmitted to a terminal device by the processing unit 65 described later, each time the transmission unit 64 described later transmits the DUD message to the terminal device. When a PDCP SN is already stored in the first memory 62, the processing unit 65 overwrites the already stored PDCP SN in the first memory 62 and stores the new PDCP SN.

A second memory 63 is configured to store a PDCP SN included in a DDDS message transmitted by the transmission unit 64 described later to the communication device 5. When a PDCP SN is already stored in the second memory 63, the processing unit 65 stores the new PDCP SN separately from the already stored PDCP SN.

The transmission unit 64 is configured to transmit a DDDS message to the communication device 5 in accordance with a result of the PDCP SN comparison performed by the processing unit 65 described later.

The processing unit 65 is configured to count a response reference time for transmitting the DDDS message as a response to the DUD message, every time the reception unit 61 receives the DUD message from the communication device 5 and the transmission unit 64 transmits the DUD message to the terminal device, and determine whether the response reference time has been reached. The determination of the response reference time may be performed by setting or resetting a timer, starting the timer, and determining that the response reference time has been reached due to expiration of the timer. The processing unit 65 is further configured to store the PDCP SN included in the DUD message transmitted to the terminal device in the first memory 62. In addition, the processing unit 65 is configured to read out the PDCP SN being stored in the first memory 62 and compare the read out PDCP SN with the PDCP SNs being stored in the second memory 63, each time the response reference time to the DUD message is reached.

Herein, the comparison between the PDCP SNs by the processing unit 65 is described. When the PDCP SN being stored in the first memory 62 matches one of the PDCP SNs being stored in the second memory 63, the transmission unit 64 does not transmit the DDDS message including the PDCP SN being stored in the first memory 62 as a response to the DUD message including the PDCP SN being stored in the first memory 62. When the PDCP SN being stored in the first memory 62 does not match any one of the PDCP SNs being stored in the second memory 63, the transmission unit 64 transmits a DDDS message including the PDCP SN being stored in the first memory 62 as a response to the DUD message including the PDCP SN being stored in the first memory 62. Then, the processing unit 65 stores, in the second memory 63, the PDCP SN included in the transmitted DDDS message and stored in the first memory 62.

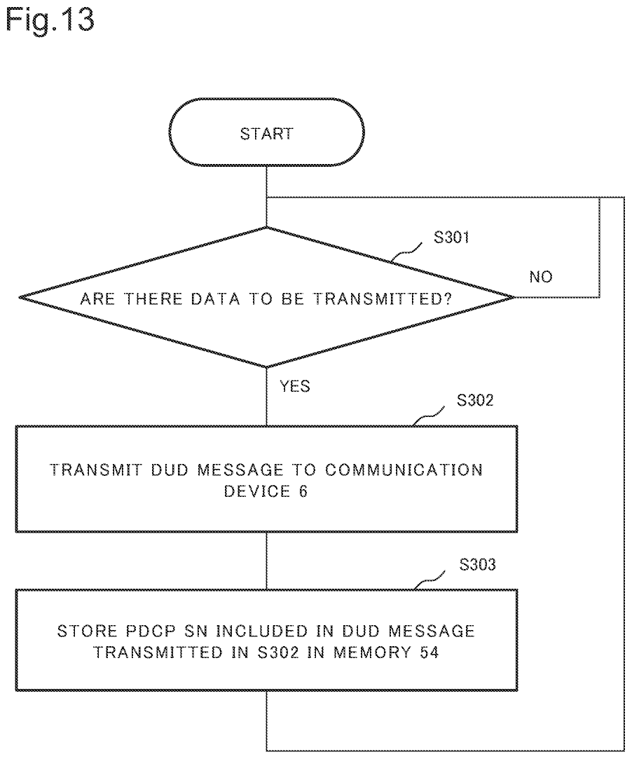

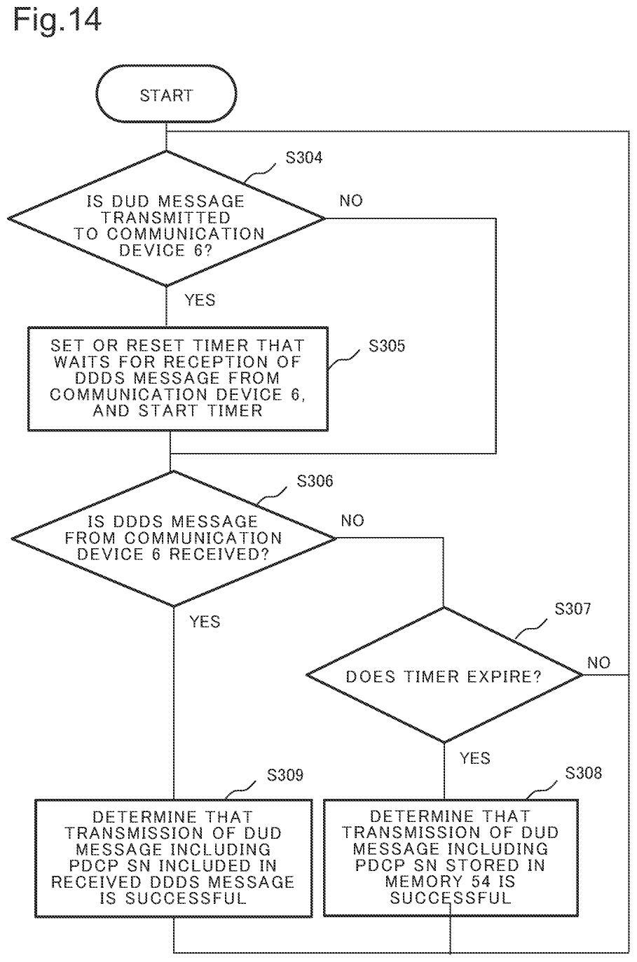

Next, an operation example of the communication device 5 according to the third example embodiment is described with reference to FIGS. 13 and 14. FIGS. 13 and 14 are flowcharts illustrating an operation example of the communication device 5 according to the third example embodiment. FIG. 13 relates in particular to the transmission of a DUD message and FIG. 14 relates in particular to the reception of a DDDS message.

In FIG. 13, the transmission unit 52 determines whether there is data to be transmitted (S301). When it is determined that there is data to be transmitted (S301, YES), the transmission unit 32 transmits a DUD message (S302). In addition, the processing unit 53 stores the PDCP SN included in the DUD message transmitted in S302 in the memory 54 (S303). Then, the processing step returns to S301. As described above, the DUD message includes a plurality of data units assigned with identification numbers. The value of the identification number circulates in such a way as to increase from the minimum value, reach the maximum value, and return to the minimum value. When it is determined that there is no data to be transmitted (S301, NO), the transmission unit 52 executes the processing of S301 again.

In FIG. 14, the reception unit 51 of the communication device 5 determines whether the transmission unit 52 has transmitted the DUD message (S304). When it is determined that the transmission unit 52 has transmitted the DUD message (S304, YES), the processing unit 53 sets or resets a timer that waits for reception of the DDDS message from the communication device 6, and starts the timer (S305). The reception unit 51 determines whether the DDDS message has been received from the communication device 6 (S306). When it is determined that the transmission unit 52 has not transmitted the DUD message (S304, NO), the processing of S304 is executed again.

The reception unit 51 of the communication device 5 determines whether a DDDS message has been received from the communication device 6 (S306).

When the reception unit 51 does not receive the DDDS message (S306, NO), the processing unit 53 of the communication device 5 further determines whether the timer started in S305 has expired (S307). If the timer has expired (S307, YES), the processing unit 53 determines that the transmission of the DUD message including the PDCP SN stored in S303 is successful. If the timer has not expired (S307, NO), the operation of S304 is performed again. In addition, when the reception unit 51 has received the DDDS message (S307, YES), the processing unit 53 determines that the transmission of the DUD message is successful (S309). Then, the operation of S304 is performed again.

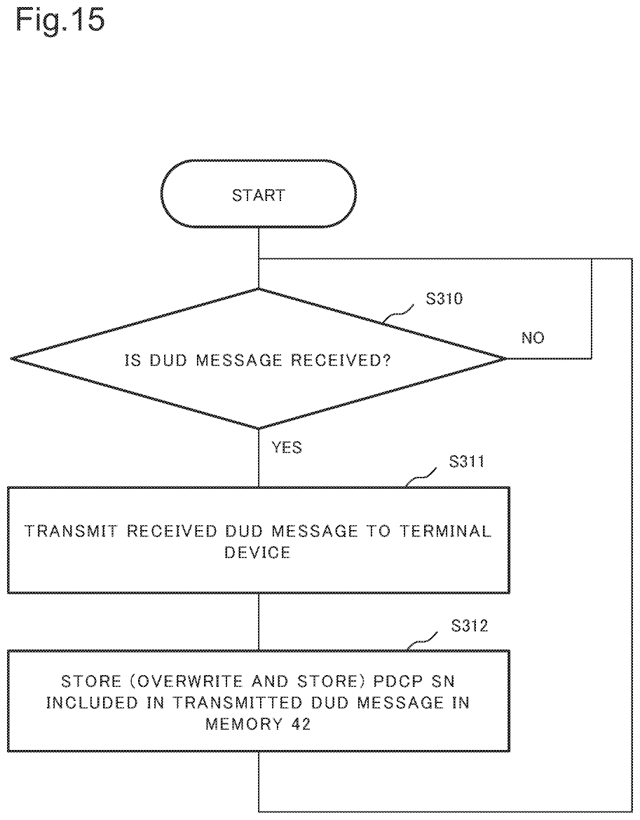

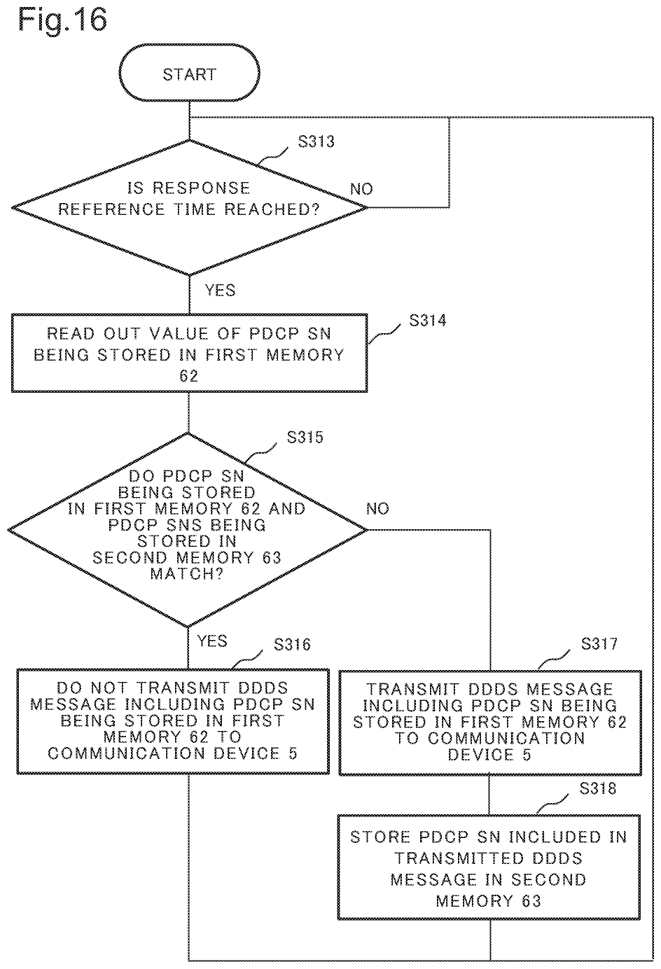

Next, an operation example of the communication device 6 according to the third example embodiment is described with reference to FIGS. 15 and 16. FIGS. 15 and 16 are flowcharts illustrating an operation example of the communication device 6 according to the third example embodiment. FIG. 15 relates in particular to storage of a PDCP SN and transmission of a DUD message, and FIG. 16 relates to comparison of PDCP SNS.

In FIG. 15, the reception unit 61 of the communication device 6 determines whether a DUD message has been received (S310).

When the processing unit 65 determines that the reception unit 61 has received the DUD message (S310, YES), the transmission unit 64 transmits the received DUD message to the terminal device (S311). Then, the processing unit 65 of the communication device 6 stores the PDCP SN included in the DUD message transmitted in S311 in the first memory 62 (S312). Note that the processing unit 65 performs the operation of S310 each time it is determined that the reception unit 61 has received a DUD message. When the processing unit 65 determines that the DUD message has not been received (S310, NO), the reception unit 61 executes the processing of S310 again.

In FIG. 16, the processing unit 65 of the communication device 6 determines whether the response reference time to the DUD message received in the processing of S310 has been reached (S313). If the response reference time has been reached, the value of the PDCP SN being stored in the first memory 62 is read out (S314).

The processing unit 65 compares the PDCP SN being stored in the first memory 62 with the PDCP SNs being stored in the second memory 63 (S315).

As a result of the comparison in S315, when the PDCP SN being stored in the first memory 62 matches any one of the PDCP SNs being stored in the second memory 63 (S315, YES), the transmission unit 64 does not transmit the DDDS message including the PDCP SN being stored in the first memory 62 as a response to the DUD message including the PDCP SN being stored in the first memory 62 (S316).

As a result of the comparison in S315, when the PDCP SN being stored in the first memory 62 does not match any one of the PDCP SNs being stored in the second memory 63 (S312, NO), the transmission unit 64 transmits a DDDS message including the PDCP SN being stored in the first memory 62 as a response to the DUD message including the PDCP SN being stored in the first memory 62 (S317). Then, the PDCP SN included in the DDDS message transmitted in step S317 is stored in the second memory 63 (S318).

As described above, the communication device 6 does not transmit, to the communication device 5, a DDDS message including the same PDCP SN as the PDCP SN transmitted in the past. Therefore, the communication device 5 is able to infer the values of HFN and COUNT regardless of the value of the PDCP SN included in the DUD message.

### Fourth Example Embodiment

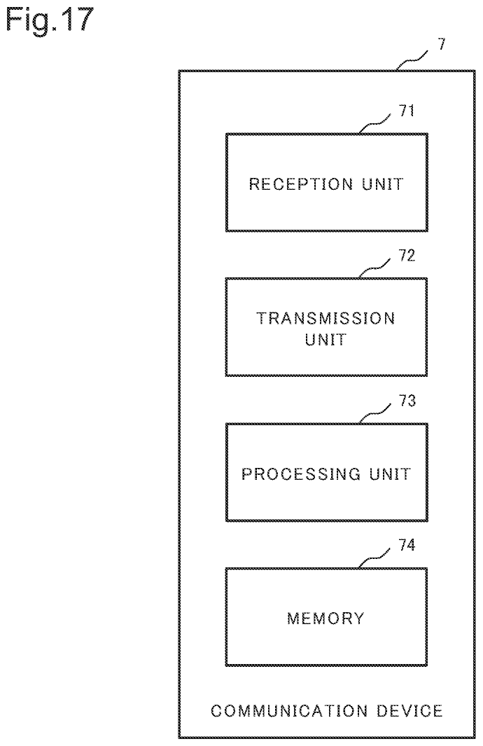

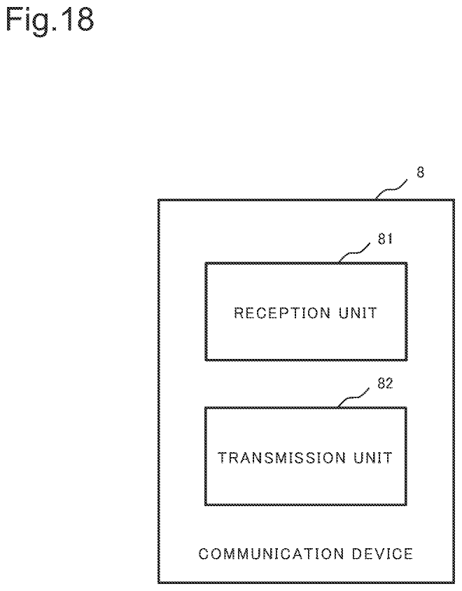

FIG. 17 illustrates a configuration example of a communication device 7 according to the present example embodiment, and FIG. 18 illustrates a configuration example of a communication device 8 according to the present example embodiment. The communication device 7 corresponds to the communication device 3 according to the second example embodiment, and the communication device 8 corresponds to the communication device 4 according to the second example embodiment. Note that description of the same operations as those in the second example embodiment is omitted as appropriate.

In FIG. 17, the communication device 7 includes a reception unit 71, a transmission unit 72, a processing unit 73, and a memory 74. The reception unit 71 corresponds to the reception unit 31 according to the second example embodiment, and the transmission unit 72 corresponds to the transmission unit 32 according to the second example embodiment.

The processing unit 73 is configured to store, in the memory 74, a PDCP SN included in the last DUD message transmitted to the communication device 8, each time the transmission unit 72 finishes transmitting the DUD message to the communication device 8. Further, the processing unit 73 is configured to, when the reception unit 71 receives a DDDS message, compare the PDCP SNs being stored in the memory 74 with the PDCP SN included in the DDDS message.

The processing unit 73 is configured to, when, as a result of the comparison between the PDCP SNs performed by the processing unit 73, the PDCP SNs being stored in the memory 74 and the PDCP SN included in the DDDS message match, determine that the PDCP SN overlaps with a PDCP SN included in a DUD message transmitted in the past. Further, the processing unit 73 is configured to determine that the DDDS message is a response to the DUD message transmitted at the most recent timing among the PDCP SNs overlapping with the DDDS message.

Note that, the processing unit 73 may compare the PDCP SN included in the last DUD message transmitted to the communication device 8 with the PDCP SNs being stored in the memory 74, each time the transmission unit 72 finishes transmitting the DUD message to the communication device 8. The processing unit 73 may be configured to operate similarly to the above-described operation when the PDCP SN included in the DUD message and the PDCP SNs being stored in the memory 74 are compared at the time of data transmission to the communication device 8, and determine whether the DDDS message is a response to the DUD message transmitted at the most recent timing among the PDCP SNs overlapping with the DDDS message.

The memory 74 is configured to store the PDCP SN included in the DUD message. If the PDCP SN is already stored in the memory 74, each PDCP SN is stored separately.

In FIG. 18, the communication device 8 includes a reception unit 81 and a transmission unit 82. The reception unit 81 corresponds to the reception unit 41 according to the second example embodiment, and the transmission unit 82 corresponds to the transmission unit 43 according to the second example embodiment.

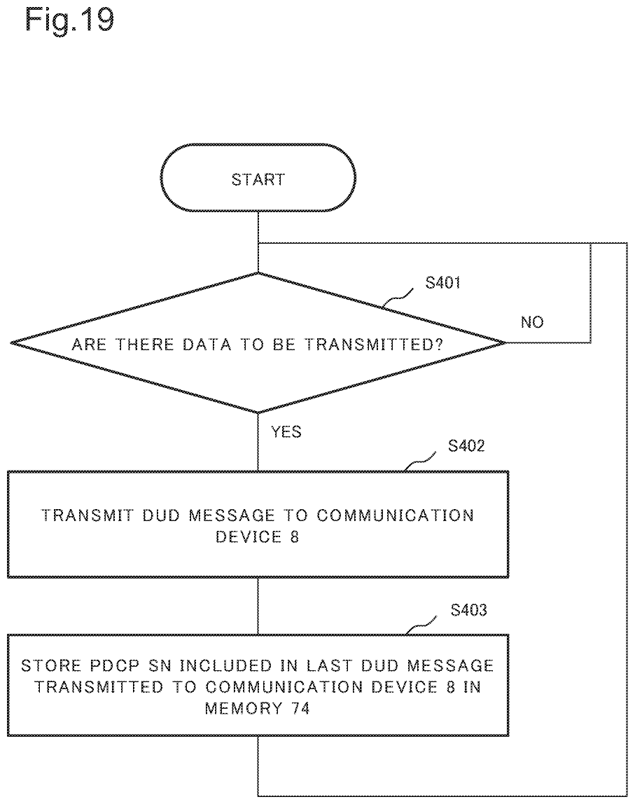

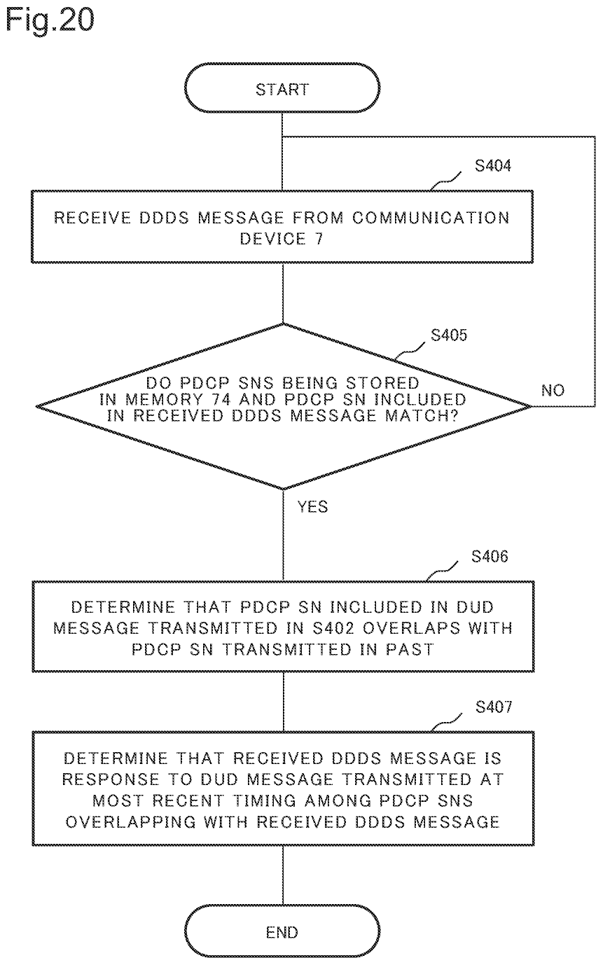

Next, an operation example of the communication device 7 according to the fourth example embodiment is described with reference to FIGS. 19 and 20. FIGS. 19 and 20 are flowcharts illustrating an operation example of the communication device 7 according to the fourth example embodiment. In particular, FIG. 19 relates to the transmission of a DUD message and FIG. 20 relates to the reception of a DDDS message.

The transmission unit 72 of the communication device 7 determines whether there is data to be transmitted (S401).

When it is determined that there is data to be transmitted (S401, YES), the transmission unit 72 of the communication device 7 transmits a DUD message to the communication device 8 (S402). When it is determined that there is no data to be transmitted (S401, NO), the transmission unit 72 executes the processing of S401 again.

Each time the transmission unit 72 finishes transmitting the DUD message to the communication device 8, the processing unit 73 of the communication device 7 stores the PDCP SN included in the last DUD message transmitted to the communication device 8 in the memory 74 (S403). Then, the processing step returns to S401.

In FIG. 20, when the reception unit 71 receives the DDDS message (S404), the processing unit 73 of the communication device 7 compares the PDCP SNs being stored in the memory 74 with the PDCP SN included in the DDDS message (S405).

When the PDCP SNs being stored in the memory 74 and the PDCP SN included in the DDDS message match as a result of the comparison of the PDCP SNs performed by the processing unit 73 of the communication device 7 (S405, YES), the processing unit 73 determines that the PDCP SN included in the DUD message transmitted in S402 overlaps with a PDCP SN transmitted in the past (S406). Then, it is determined that the DDDS message is a response to the DUD message transmitted at the most recent timing among the PDCP SNs overlapping with the DDDS message (S407).

When the PDCP SNs being stored in the memory 74 and the PDCP SN included in the DDDS message do not match as a result of the comparison between the PDCP SNs (S405, NO), the processing unit 73 of the communication device 7 executes S404 again.

As described above, the communication device 7 is able to determine that the DDDS message including the same PDCP SN as a PDCP SN transmitted in the past is a response to a DUD message transmitted at the most recent timing. Therefore, the communication device 7 is able to infer the values of HFN and COUNT regardless of the value of the PDCP SN included in the DDDS message.

### Other Example Embodiments

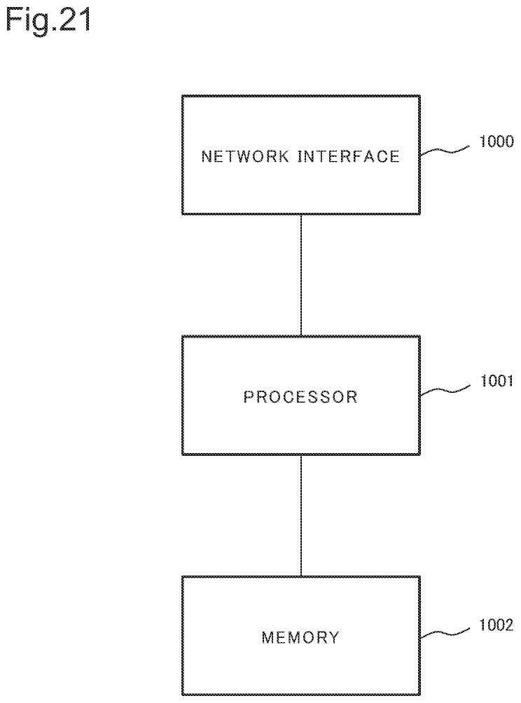

The communication devices 1 to 8 according to the above-described example embodiments (hereinafter, referred to as the communication device 1 and the like) may have the following hardware configuration. FIG. 21 is a block diagram illustrating an example of a hardware configuration of a computer (information processing device) capable of achieving the communication device according to each example embodiment.

Referring to FIG. 21, the communication device 1 and the like include a network interface 1000, a processor 1001, and a memory 1002. The network interface 1000 is being used to communicate with other wireless communication devices including a plurality of communication terminals. The network interface 1000 may include, for example, a network interface card (NIC) compliant with IEEE 802.11 series, IEEE 802.3 series or the like.

The processor 1001 reads and implements software (computer program) from the memory 1002 and thereby executes processing of the communication device 1 and the like described with reference to the flowcharts and the sequence diagrams in the above-described example embodiments. The processor 1001 may be, for example, a microprocessor, a micro processing unit (MPU), or a central processing unit (CPU). The processor 1001 may include a plurality of processors.

The memory 1002 includes a combination of a volatile memory and a non-volatile memory. The memory 1002 may include storage located remotely from the processor 1001. In such a case, the processor 1001 may access the memory 1002 via an I/O interface (not illustrated).

In the example of FIG. 21, the memory 1002 is being used to store software modules. The processor 1001 is able to read and implement the software modules from the memory 1002 and thereby execute the processing of the communication device 1 and the like described in the above-described example embodiments.

As described with reference to FIG. 20, each of the processors included in the communication device 1 or the like executes one or more programs including instructions for causing a computer to perform the algorithm described with reference to the drawings.

In the examples described above, the programs may be stored and provided to the computer by using various types of non-transitory computer readable media. Non-transitory computer-readable media include various types of tangible storage media. Examples of non-transitory computer readable media include a magnetic recording medium (e.g., a flexible disk, a magnetic tape, and a hard disk drive), and a magneto-optical recording medium (e.g., a magneto-optical disk). Further, examples of non-transitory computer-readable media include a CD-read only memory (ROM), a CD-R, and a CD-R/W. In addition, examples of non-transitory computer readable media include a semiconductor memory. The semiconductor memory includes, for example, a mask ROM, a programmable ROM (PROM), an erasable PROM (EPROM), a flash ROM, and a random access memory (RAM). The program may also be provided to the computer by various types of transitory computer readable media. Examples of transitory computer readable media include electrical signals, optical signals, and electromagnetic waves. The transitory computer readable medium may supply the program to the computer via a wired communication path such as an electric wire and an optical fiber, or a wireless communication path.

Note that, the present disclosure is not limited to the above-described example embodiments, and can be appropriately modified without departing from the scope of the present disclosure. Further, the present disclosure may be implemented by appropriately combining each of the example embodiments.

For example, some or all of the above-described example embodiments may be described as the following supplementary notes, but are not limited thereto.

### Supplementary Note 1

A communication device being a first communication device that communicates with a terminal device together with a second communication device, the communication device comprising:
a transmission means for sequentially transmitting, via the second communication device or directly to the terminal device, a plurality of messages including a plurality of data units in which an identification number is assigned to each data unit, wherein a value of the identification number circulates in such a way as to increase from a minimum value, reach a maximum value, and then return to the minimum value; and
a reception means for receiving, from the second communication device, a response message including a value of the identification number being held in a memory provided in the second communication device, the value of the identification number being included in the last data unit transmitted from the second communication device to the terminal device before a response reference timing of the second communication device, wherein
the transmission means transmits, to the second communication device, control information indicating that the value of the identification number being stored in the memory provided in the second communication device is to be deleted, after the reception means receives the response message including a first value of the identification number, and before the transmission means transmits a data unit including the same value as the first value of the identification number.

### Supplementary Note 2

The communication device according to supplementary note 1, wherein the identification number is a packet data convergence protocol sequence number (PDCP SN).

### Supplementary Note 3

The communication device according to supplementary note 2, wherein the PDCP SN is a part of COUNT.

### Supplementary Note 4

The communication device according to supplementary note 3, wherein the COUNT includes the PDCP SN and a hyper frame number (HFN).

### Supplementary Note 5

The communication device according to any one of supplementary notes 2 to 4, wherein the transmission means transmits the control information after the PDCP SN changes.

### Supplementary Note 6

The communication device according to any one of supplementary notes 2 to 5, wherein the transmission means transmits the control information at a time when a value of the PDCP SN becomes 0.

### Supplementary Note 7

The communication device according to any one of supplementary notes 2 to 6, wherein the transmission means transmits the control information before the most significant bit of the PDCP SN changes.

### Supplementary Note 8

The communication device according to any one of supplementary notes 2 to 6, wherein the transmission means transmits the control information after the most significant bit of the PDCP SN changes.

### Supplementary Note 9

The communication device according to any one of supplementary notes 1 to 8, wherein the control information is a reset flag.

### Supplementary Note 10

The communication device according to any one of supplementary notes 1 to 9, wherein the plurality of messages including the plurality of data units assigned with identification numbers are DL USER DATA messages, and the response message is a DL DATA DELIVERY STATUS PDU message.

### Supplementary Note 11

The communication device according to any one of supplementary notes 1 to 10, wherein at least one of the first communication device and the second communication device is a base station communicating with the terminal device by using a dual connectivity split bearer.

### Supplementary Note 12

The communication device according to supplementary note 11, wherein the first communication device is any one of a central unit (CU) of the base station, a master base station in the dual connectivity, and a secondary base station in the dual connectivity.

### Supplementary Note 13

The communication device according to supplementary note 11 or 12, wherein the second communication device is any one of a distributed unit (DU) of the base station, a master base station in the dual connectivity, and a secondary base station in the dual connectivity.

### Supplementary Note 14

The communication device according to supplementary note 12 or 13, wherein the master base station is an MeNB or an MgNB, and the secondary base station is an SeNB or an SgNB.

### Supplementary Note 15

A communication device being a second communication device that communicates with a terminal device together with a first communication device, the communication device comprising:
a reception means for sequentially receiving, from the first communication device, a plurality of messages including a plurality of data units in which an identification number is assigned to each data unit, wherein a value of the identification number circulates in such a way as to increase from a minimum value, reach a maximum value, and then return to the minimum value; and
a transmission means for transmitting, to the first communication device, a response message including a value of the identification number held in a memory of the second communication device, the value of the identification number being included in the last data unit received before a response reference timing of the second communication device, wherein
the reception means receives, from the first communication device, control information indicating that the value of the identification number being stored in the memory provided in the second communication device is to be deleted, after the transmission means transmits a response message including a first value of the identification number, and before the reception means receives a data unit including the same value as the first value of the identification number.

### Supplementary Note 16

The communication device according to supplementary note 15, wherein the transmission means does not transmit the response message to the first communication device, after the reception means receives the control information.

### Supplementary Note 17

The communication device according to supplementary note 15, wherein the transmission means transmits a response message that does not include the identification number to the first communication device, after the reception means receives the control information.

### Supplementary Note 18

The communication device according to supplementary note 15, wherein the response message including the identification number is at least one of a highest transmitted NR PDCP sequence number (HTSN), a highest successfully delivered NR PDCP sequence number (HDSN), a successfully delivered retransmitted NR PDCP sequence number (SDSN), and a retransmitted NR PDCP sequence number (RSN), and the HTSN, the HDSN, the SDSN, and the RSN include the identification number.

### Supplementary Note 19

A method being a method of a first communication device communicating with a terminal device together with a second communication device, the method comprising:
sequentially transmitting, via the second communication device or directly to the terminal device, a plurality of messages including a plurality of data units in which an identification number is assigned to each data unit, wherein a value of the identification number circulates in such a way as to increase from a minimum value, reach a maximum value, and then return to the minimum value;
receiving, from the second communication device, a response message including a value of the identification number being held in a memory of the second communication device, the value of the identification number being included in the last data unit transmitted from the second communication device to the terminal device before a response reference timing of the second communication device; and
transmitting, to the second communication device, control information indicating that the value of the identification number being stored in the memory provided in the second communication device is to be deleted, after receiving the response message including a first value of the identification number, and before transmitting a data unit including the same value as the first value of the identification number.

### Supplementary Note 20

A method being a method of a second communication device communicating with a terminal device together with a first communication device, the method comprising:
sequentially receiving, from the first communication device, a plurality of messages including a plurality of data units in which an identification number is assigned to each data unit, wherein a value of the identification number circulates in such a way as to increase from a minimum value, reach a maximum value, and then return to the minimum value;
transmitting, to the first communication device, a response message including a value of the identification number being held in a memory of the second communication device, the value of the identification number being included in the last data unit received before a response reference timing of the second communication device; and
receiving, from the first communication device, control information indicating that the value of the identification number being stored in the memory provided in the second communication device is to be deleted, after transmitting a response message including a first value of the identification number, and before receiving a data unit including the same value as the first value of the identification number.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese patent application No. 2021-160256, filed on Sep. 30, 2021, the disclosure of which is incorporated herein in its entirety by reference.

### REFERENCE SIGNS LIST

1 to 8 Communication device
11, 23, 32, 43, 52, 72, 82 Transmission unit
12, 21, 31, 41, 51, 61, 71, 81 Reception unit
22, 42, 54 Memory
33, 44, 53, 73 Processing unit
62 First memory
63 Second memory
74, 1002 Memory
1000 Network interface
1001 Processor

What is claimed is:

1. A method of a first communication device that communicates with a terminal device together with a second communication device, the method comprising:
sequentially transmitting, via the second communication device or directly to the terminal device, a plurality of messages including a plurality of data units in which an identification number is assigned to each data unit, wherein a value of the identification number circulates in such a way as to increase from a minimum value, reach a maximum value, and then return to the minimum value;
receiving, from the second communication device, a response message including a value of the identification number being held in a memory provided in the second communication device, the value of the identification number being included in a last data unit transmitted from the second communication device to the terminal device before a response reference timing of the second communication device; and
transmitting, to the second communication device, control information indicating that the value of the identification number being stored in the memory provided in the second communication device is to be deleted, after receiving the response message including a first value of the identification number, and before transmitting a data unit including a same value as the first value of the identification number.

2. The method according to claim 1, wherein the identification number is a packet data convergence protocol sequence number (PDCP SN).

3. The method according to claim 2, wherein the PDCP SN is a part of COUNT.

4. The method according to claim 3, wherein the COUNT includes the PDCP SN and a hyper frame number (HFN).

5. The method according to claim 2, wherein the control information is transmitted after the PDCP SN changes.

6. The method according to claim 2, wherein the control information is transmitted at a time when a value of the PDCP SN becomes 0.

7. The method according to claim 2, wherein the control information is transmitted before a most significant bit of the PDCP SN changes.

8. The method according to claim 2, wherein the control information is transmitted after a most significant bit of the PDCP SN changes.

9. The method according to claim 1, wherein the control information is a reset flag.

10. The method according to claim 1, wherein the plurality of messages including the plurality of data units assigned with identification numbers are DL USER DATA messages, and the response message is a DL DATA DELIVERY STATUS PDU message.

11. The method according to claim 1, wherein at least one of the first communication device and the second communication device is a base station communicating with the terminal device by using a dual connectivity split bearer.

12. The method according to claim 11, wherein the first communication device is any one of a central unit (CU) of the base station, a master base station in the dual connectivity, and a secondary base station in the dual connectivity.

13. The method according to claim 11, wherein the second communication device is any one of a distributed unit (DU) of the base station, a master base station in the dual connectivity, and a secondary base station in the dual connectivity.

14. The method according to claim 12, wherein the master base station is an MeNB or an MgNB, and the secondary base station is an SeNB or an SgNB.

15. A method of a second communication device that communicates with a terminal device together with a first communication device, the method comprising:
sequentially receiving, from the first communication device, a plurality of messages including a plurality of data units in which an identification number is assigned to each data unit, wherein a value of the identification number circulates in such a way as to increase from a minimum value, reach a maximum value, and then return to the minimum value;
transmitting, to the first communication device, a response message including a value of the identification number held in a memory of the second communication device, the value of the identification number being included in a last data unit received before a response reference timing of the second communication device; and
receiving, from the first communication device, control information indicating that the value of the identification number being stored in the memory provided in the second communication device is to be deleted, after transmitting a response message including a first value of the identification number, and before receiving a data unit including a same value as the first value of the identification number.

16. The method according to claim 15, wherein the response message is not transmitted to the first communication device, after receiving the control information.

17. The method according to claim 15, wherein a response message that does not include the identification number is transmitted to the first communication device, after receiving the control information.

18. The method according to claim 15, wherein the response message including the identification number is at least one of a highest transmitted NR PDCP sequence number (HTSN), a highest successfully delivered NR PDCP sequence number (HDSN), a successfully delivered retransmitted NR PDCP sequence number (SDSN), and a retransmitted NR PDCP sequence number (RSN), and the HTSN, the HDSN, the SDSN, and the RSN include the identification number.

19. A communication device being a first communication device communicating with a terminal device together with a second communication device, the communication device comprising one or more memories storing instructions and one or more processors configured to execute the instructions to:
sequentially transmit, via the second communication device or directly to the terminal device, a plurality of messages including a plurality of data units in which an identification number is assigned to each data unit, wherein a value of the identification number circulates in such a way as to increase from a minimum value, reach a maximum value, and then return to the minimum value;
receive, from the second communication device, a response message including a value of the identification number being held in a memory of the second communication device, the value of the identification number being included in a last data unit transmitted from the second communication device to the terminal device before a response reference timing of the second communication device; and
transmit, to the second communication device, control information indicating that the value of the identification number being stored in the memory provided in the second communication device is to be deleted, after receiving the response message including a first value of the identification number, and before transmitting a data unit including a same value as the first value of the identification number.

20. (canceled)
